(19) United States
(12) Patent Application Publication
(10) Pub. No.: US 2023/0082450 A1
(43) Pub. Date: Mar. 16, 2023

(54) ELECTROWINNING CELLS FOR THE SEGREGATION OF THE CATHODIC AND ANODIC COMPARTMENTS

(71) Applicant: University of Kentucky Research Foundation, Lexington, KY (US)

(72) Inventor: Joshua M Werner, Lexington, KY (US)

(21) Appl. No.: 17/797,687

(22) PCT Filed: Feb. 8, 2021
(86) PCT No.: PCT/US21/17104

§ 371 Date: Aug. 4, 2022

Related U.S. Application Data
(60) Provisional application No. 62/971,472, filed on Feb. 7, 2020.
(60) Provisional application No. 62/972,405, filed on Feb. 10, 2020.

(51) Int. Cl. C25C 7/04; C25C 1/12

(52) U.S. Cl. CPC C25C 7/04; C25C 1/12

(57) ABSTRACT

An electrowinning cell includes a first anode associated with a first anode compartment, a cathode in a cathode compartment, a second anode associated with a second anode compartment, a first spacer plate between the first anode and the cathode and a second spacer plate between the cathode and the second anode compartment.

### RELATED APPLICATION

This application claims priority to U.S. Provisional Patent Application Ser. No. 62/972,405 filed on Feb. 10, 2020 and U.S. Provisional Patent Application Ser. No. 62/971,472 filed on Feb. 7, 2020, both of which are hereby incorporated by reference in their entirety.

### TECHNICAL FIELD

This document relates generally to the field of electrochemical reactors and methods for recovering elemental metal from an electrolyte containing ions of that metal.

### BACKGROUND

This document relates to (a) a new and improved spacer plate for an electrowinning cell, (b) a new and improved electrowinning cell incorporating that spacer plate, (c) a new and improved electrowinning press incorporating a plurality of those electrowinning cells and (d) a new and improved method for recovering elemental metal from an electrolyte incorporating ions of that metal.

### SUMMARY

In accordance with the purposes and benefits described herein, a new and improved spacer plate is provided for use in an electrowinning cell. That spacer plate comprises a body outlining sidewalls of an electrolyte chamber. The body includes an electrolyte inlet and an electrolyte outlet. A flow restrictor carried on the body extends across the electrolyte chamber and divides the electrolyte chamber into a cathode compartment and an anode compartment. Additional details of the spacer plate are described below in the Detailed Description.

In accordance with yet another aspect, a new and improved electrowinning cell is provided that incorporates the aforementioned spacer plate. That electrowinning cell comprises: (a) a first anode associated with a first anode compartment (b) a cathode in a cathode compartment, (c) a second anode associated with a second anode compartment, (d) a first spacer plate and (e) a second spacer plate.

The first spacer plate is positioned between the first anode and the cathode. The first spacer plate includes a first body outlining sidewalls of an electrolyte chamber. The first body includes a first electrolyte inlet, a first electrolyte outlet and a first flow restrictor. The first flow restrictor extends across the electrolyte chamber and divides the electrolyte chamber into the cathode compartment and the first anode compartment.

The second spacer plate is positioned between the cathode and the second anode. The second spacer plate includes a second body that also outlines the sidewalls of the electrolyte chamber. The second body includes a second electrolyte inlet, a second electrolyte outlet and a second flow restrictor. The second flow restrictor extends across the electrolyte chamber and divides the electrolyte chamber into the cathode compartment and the second anode compartment.

Additional details of the electrowinning cell are described below in the Detailed Description.

In accordance with still another aspect, a new and improved electrowinning press is provided that incorporates a plurality of the aforementioned electrowinning cells. The electrowinning press comprises: (a) a frame, (b) a first end plate carried on the frame, (c) a second end plate carried on said frame, (d) a plurality of electrowinning cells carried on the frame between the first end plate and the second end plate and (e) a clamp assembly adapted to clamp the plurality of electrowinning cells between the first end plate and the second end plate. Additional details of the electrowinning press are described below in the Detailed Description.

In accordance with yet another aspect, a new and improved method of electrowinning a metal from an electrolyte containing ions of that metal comprises the step of passing the electrolyte with the ions of the metal through the new and improved electrowinning cell. This includes, but is not limited to, the winning of copper metal from the electrolyte comprising copper ions in ammoniacal solution.

Further a new and improved method of electrowinning a metal from an electrolyte containing ions of that metal, comprises the steps of: (a) loading a plurality of electrowinning cells into an electrowinning press, (b) passing the electrolyte in parallel through the plurality of electrowinning cells held in the electrowinning press and (c) collecting the metal at a cathode of each of the electrowinning cells.

In the following description, there are shown and described several preferred embodiments of the spacer plate, electrowinning cell, electrowinning press and related methods of electrowinning a metal from an electrolyte containing ions of that metal. As it should be realized, the spacer plate, electrowinning cell, electrowinning press and related methods are capable of other, different embodiments and their several details are capable of modification in various, obvious aspects all without departing from the spacer plate, electrowinning cell, electrowinning press and related methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the spacer plate, the electrowinning cell, the electrowinning press and the method and together with the description serve to explain certain principles thereof.

FIG. 1 is a perspective view of the new and improved electrowinning cell.

FIG. 2 is a side elevational view of the electrowinning cell illustrated in FIG. 1.

FIG. 3 is a longitudinal cross-sectional view of the electrowinning cell illustrated in FIGS. 1 and 2 illustrating the flow of electrolyte through that cell.

FIG. 4 is a front plan view of a first face of the spacer plate used in the electrowinning cell of FIGS. 1-3.

FIG. 5 is a rear plan view of the second, opposite face of the spacer plate used in the electrowinning cell of FIGS. 1-3.

FIG. 6 is a transverse cross-sectional view of the spacer plate illustrating the plurality of inlet ports that deliver electrolyte to the cathode compartment of the electrowinning cell.

FIG. 7 is a perspective view of an electrowinning press incorporating a plurality of electrowinning cells of the type illustrated in FIGS. 1-3.

FIG. 8 is a detailed illustration of an electrowinning cell held in the frame of the electrowinning press.

FIG. 9 is a schematic representation of the electrowinning of copper in ammoniacal solutions.

Reference will now be made in detail to the present preferred embodiments of the new and improved spacer plate, the electrowinning cell, the electrowinning press and the method, examples of which are illustrated in the accompanying drawing figures.

### DETAILED DESCRIPTION

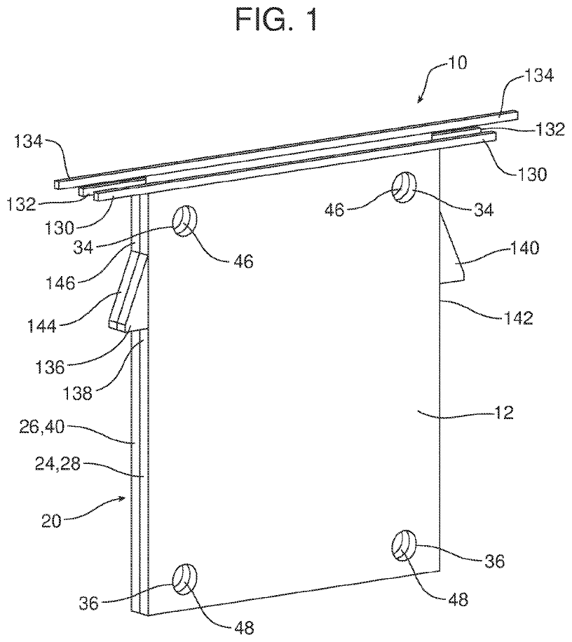

Reference is now made to FIGS. 1-3 illustrating a new and improved electrowinning cell 10. The electrowinning cell 10 includes a first anode 12, a first anode compartment 14, a cathode 16, a cathode compartment 18, a second anode 20 and a second anode compartment 22. A first spacer plate 24 is provided between the first anode 12 and the cathode 16. A second spacer plate 26 is provided between the cathode 16 and the second anode 20.

The first and second anodes 12, 20 may be made from any appropriate material including, for example, graphite, lead and lead alloys, platinized titanium, and a mixed metal oxide. The cathode 16 may be made from any appropriate material including, for example, stainless steel, a starter sheet composed of the metal to be deposited, molybdenum, or a suitable material for the reduction of the electroactive metal. The spacer plates 24, 26 may be made from any appropriate electrically insulating material including, for example, polypropylene, polyethene, PEEK (polyether ether ketone), PVC (polyvinyl chloride), and CPVC.

The first spacer plate 24 includes a first body 28 outlining sidewalls 30 of an electrolyte chamber 32. The first body 28 includes a first electrolyte inlet 34, a first electrolyte outlet 36 and a first flow restrictor 38. That first flow restrictor 38 extends across the first electrolyte chamber 32 and divides the first electrolyte chamber into the cathode compartment 18 and the first anode compartment 14.

The second spacer plate 26 includes a second body 40 also outlining the sidewalls 30 of the electrolyte chamber 32. The second body 28 includes a second electrolyte inlet 46, a second electrolyte outlet 48 and a second flow restrictor 50. That second flow restrictor 50 extends across the electrolyte chamber 32 and divides the electrolyte chamber into the cathode compartment 18 and the second anode compartment 22.

The flow restrictors 38, 50 may be made from any appropriate material adapted to restrict the flow of electrolyte from the cathode compartment 18 to the node compartments 14, 22 such that the hydrodynamic conditions prevent the conveyance of the species oxidized at the anode (if it may be reduced at the cathode) to be transported to the cathode where it may be reduced, where cathodic deposition of material is contemplated, collected at the cathode 18. Appropriate materials for use as flow restrictors 38, 50 include, polypropylene, polyethylene, or any such material as is resistive to the electrolyte and may be manufactured with sufficiently small porosity to providing an electrolyte flow rate generally above the diffusion or migration speed of the species which is oxidized at the anode and which may be reduced at the cathode.

As should be appreciated, the first and second electrolyte inlets 34, 46 are in communication with the cathode compartment 18. The first electrolyte outlet 36 is in communication with the first anode compartment 14. The second electrolyte outlet 48 is in communication with the second anode compartment 22. Further, the cathode compartment 18, divided by the cathode 16 into two sections, is provided between the two flow restrictors 38, 50 and the two anode compartments 14, 22.

An electrolyte inlet plenum 52 formed in the first and second bodies 28, 40 of the spacer plates 24, 26 extends across a first sidewall 54 of the electrolyte chamber 32. A first plurality of inlet ports 60 in the first body 28 at the first sidewall 54 of the electrolyte chamber 32 allow electrolyte to flow from the first electrolyte inlet 34 through the electrolyte inlet plenum 52 and then through the first plurality of inlet ports into the cathode compartment 18. Similarly, a second plurality of inlet ports 62 in the second body 40 at the first sidewall 54 of the electrolyte chamber 32 allow electrolyte to flow from the second electrolyte inlet 46 through the electrolyte inlet plenum 52 and then through the second plurality of inlet ports into the cathode compartment 18.

The electrowinning cell 10 also includes a first electrolyte outlet plenum 63 in the first body 28 that extends across a second sidewall 64 of the electrolyte chamber 32 and a second electrolyte outlet plenum 66 in the second body 40 that extends across the second sidewall 64 of the electrolyte chamber. A first plurality of outlet ports 68 may be provided in the first body 28 at the second sidewall 64 of the first electrolyte chamber 32. This allows electrolyte to flow from the first anode compartment 14 through the first plurality of outlet ports 68 and then through the first electrolyte outlet plenum 62 to the first electrolyte outlet 36.

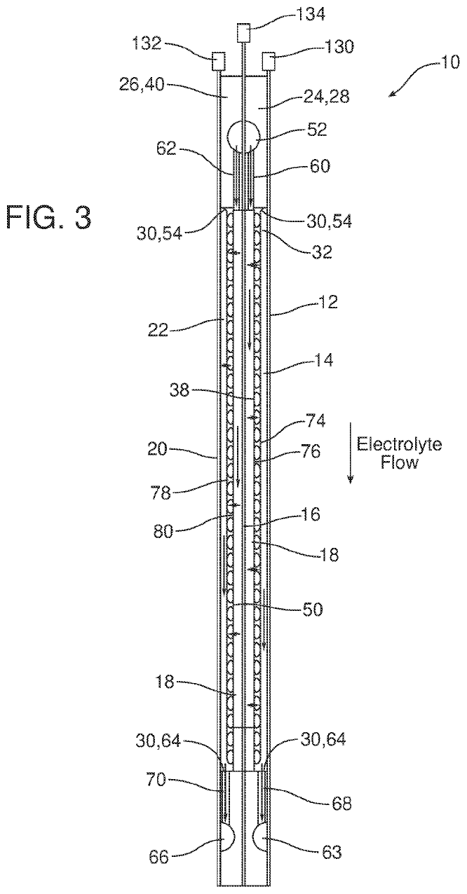

A second plurality of outlet ports 70 may be provided in the second body 40 at the second sidewall 64 of the electrolyte chamber 32. This allows electrolyte to flow from the second anode compartment 22 through the second plurality of outlet ports 70 and then through the second electrolyte outlet plenum 66 to the second electrolyte outlet 48. See action arrows in FIG. 3 illustrating the flow of electrolyte through the cell 10. As should be appreciated from reviewing FIG. 3, the first sidewall 54 of the electrolyte chamber 32 is opposite the second sidewall 64 of the electrolyte chamber.

As best illustrated in FIG. 3, a first flow restrictor 74 (a) extends across the electrolyte chamber 32 against a face 76 of the first flow restrictor 38 and (b) is oriented toward the first anode compartment 14. Similarly, a second flow restrictor support 78 (a) extends across the electrolyte chamber 32 against a face 80 of the second flow restrictor 50 and (b) is oriented toward the second anode compartment 22. The flow restrictor supports 74, 78 are of sufficient area and strength to prevent collapse of the flow restrictors 38, 50 onto the anodes 12, 20 as electrolyte moves through the cell 10. Some embodiments of the cell 10 may not require these supports 74, 78.

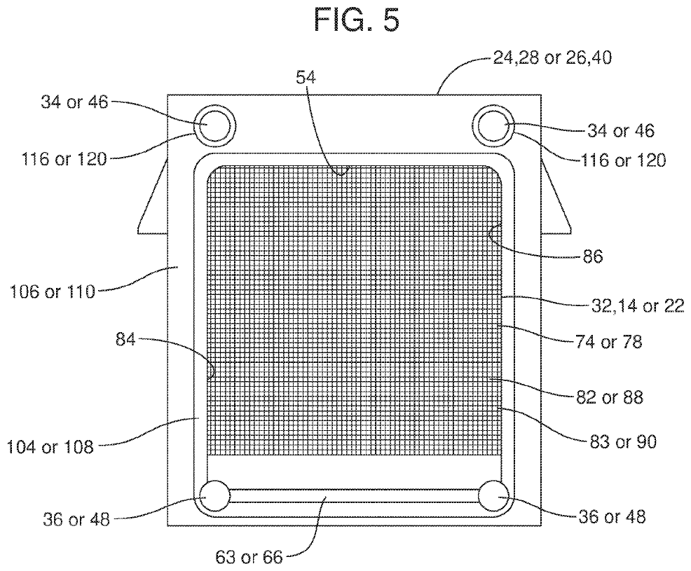

As best illustrated in FIG. 5, the first flow restrictor support 74 includes a first plurality of apertures 82 between a plurality of ribs or supports 83 extending across the electrolyte chamber 32 in a first direction between the first sidewall 54 and the second sidewall 64 of the first electrolyte chamber and in a second direction between a third sidewall 84 and a fourth sidewall 86 opposite the third sidewall of the first electrolyte chamber.

Similarly, as alternatively illustrated in FIG. 5, the second flow restrictor support 78 includes a second plurality of apertures 88 between a plurality of ribs or supports 90 extending across the electrolyte chamber 32 in the first direction between the first sidewall 54 and the second sidewall 64 and in the second direction between a third sidewall 84 and a fourth sidewall 86 opposite the third sidewall of the electrolyte chamber.

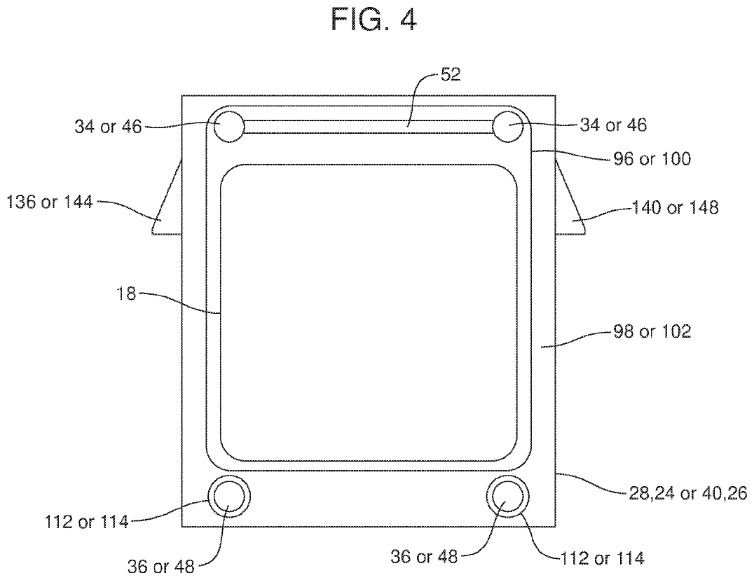

As illustrated in FIG. 4, a first seal 96 on a first side 98 of the first body 28 extends around the first electrolyte inlet 34, the electrolyte inlet plenum 52 and the cathode compartment 18. As alternatively illustrated in FIG. 4, a first seal 100 on the first side 102 of the second body 40 extends around the second electrolyte inlet 46, the electrolyte inlet plenum 52 and the cathode compartment 18. To those skilled in the art, it is understood that the seals or gaskets represented in this embodiment of 112, 114, 96, 100, 116, 120 may be arranged in such a way to prevent conduction through the electrolyte in either the inlets 34,46, or outlets 36,48 so that plating does not occur outside the cathode chamber 18.

As illustrated in FIG. 5, a second seal 104 on a second side 106 of the first body 28 extends around the first electrolyte outlet 36, the first outlet plenum 62 and the first anode compartment 14. As alternatively illustrated in FIG. 5, a second seal 108 on a second side 110 of the second body 40 extends around the second electrolyte outlet 48, second outlet plenum 66 and second anode compartment 22.

A third seal 112 on the first side 98 of the first body 28 extends around the first electrolyte outlet 36 (see FIG. 4). As alternatively illustrated in FIG. 4, a third seal 114 on the first side 102 of the second body 40 extends around the second electrolyte outlet 48. A fourth seal 116 on the second side 106 of the first body 28 extends around the first electrolyte inlet 34 (see FIG. 5). As alternatively illustrated in FIG. 5, a fourth seal 120 on the second side 110 of the second body 40 extends around the second electrolyte inlet 46.

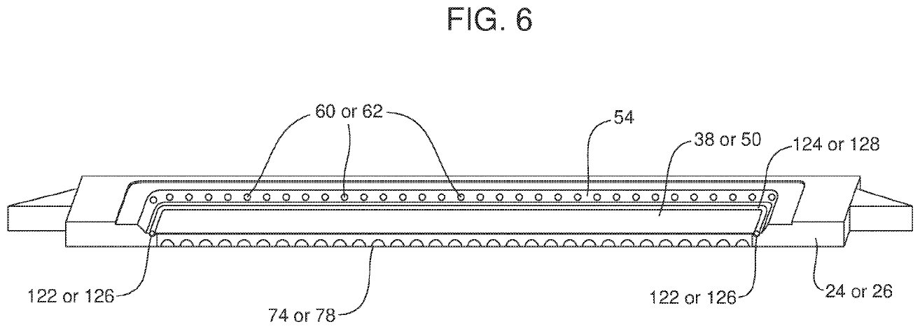

As best illustrated in FIG. 6, the first body 28 further includes a first channel 122 outlining the cathode compartment 18. A first deformable band 124, such as a snap ring, is pressed against the first flow restrictor 38 down into this channel 122 in order to hold the first flow restrictor in place. Similarly, as alternatively illustrated in this Figure, the second body 40 includes a second channel 126 outlining the cathode chamber 18. A second deformable band 128 is pressed against the second flow restrictor 50 down into this second channel 126 in order to hold the second flow restrictor in place.

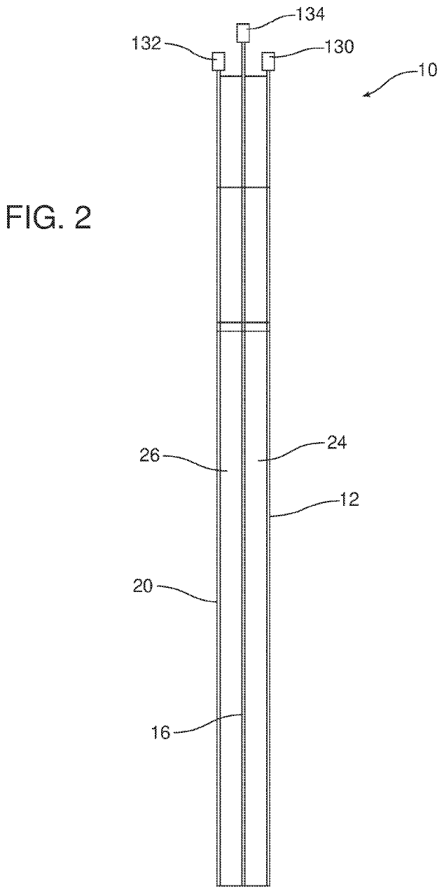

A first anode bar 130 is provided at the top end of the first anode 12. A second anode bar 132 is provided at the top end of the second anode 20. A cathode bar 134 is provided at the top end of the cathode 16. In the illustrated embodiments, the first and second anode bars 130, 132 are height aligned: that is extend or project upwardly to an equal height. In contrast, the cathode bar 134 is height offset from the first and second height aligned anode bars. More particularly, in the illustrated embodiment, the cathode bar 134 extends further or to a greater height than the anode bars 130, 132 (see for example, FIGS. 1 and 2). Further, it should be appreciated that the cathode bar 134 is longer than the anode bars 130, 132 and therefore, extends outboard of the anode bars at both lateral ends. Those skilled in the art understand that such heights or lateral arrangements are arbitrary, and any number of designs too numerous to mention are found in electrowinning for cathode/anode bar arrangements. This allows for simple electrical connection of the electrowinning cell 10.

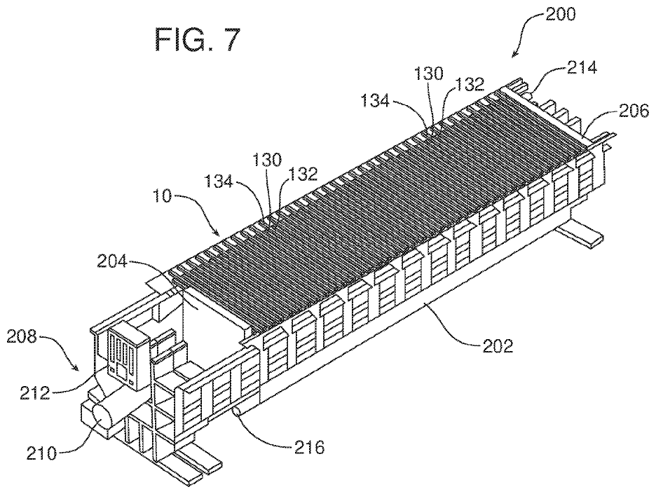

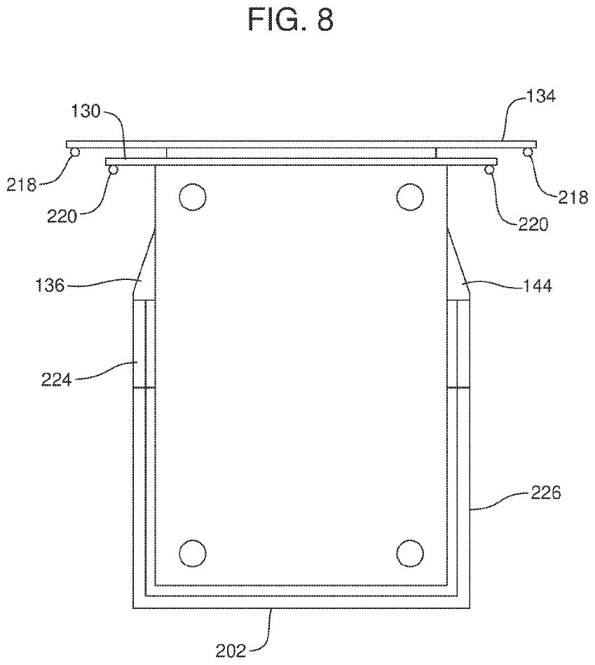

As best shown in FIGS. 1 and 4, a first support lug 136 projects from a first edge 138 of the first body 28 and a second support lug 140 projects from a second edge 142 of the first body. Similarly, a first support lug 144 projects from a first edge 146 of the second body 40 and a second support lug 148 projects from a second edge of the second body. As illustrated in FIGS. 7 and 8 and described below, the opposing lugs 122 and 126 provide a means for hanging spacer plates of the electrowinning cell 10 on the frame 202 of an electrowinning press 200 when open. Note that the cathode and anode bars, 130, 132, 134 provide the same function when the press is open, resting on the bus bars 220 and 218.

The electrowinning press 200, shown in FIG. 8, includes the frame 202, a first end plate 204 carried on the frame and a second end plate 206 carried on the frame. A plurality of electrowinning cells 10, of the type described above and illustrated in drawing FIGS. 1-6, are carried on the frame between the first and second end plates 204, 206. A clamp assembly, generally designated by reference numeral 208, is adapted to clamp the plurality of electrowinning cells 10 together between the first and second end plates 204, 206 so that the first, second, third and fourth seals 96, 100, 104, 108, 112, 114, 116 and 120 are compressed to seal the various compartments 14, 18, 22 and plenums 52, 56, 62 and 66.

In the illustrated embodiment, the clamp assembly 208 includes an actuator 210 adapted to urge the first end plate 204 and the second end plate 206 together. A controller 212, in the form of a dedicated microprocessor or electronic control unit operating in accordance with instructions from appropriate control software may be connected to the actuator 210 and adapted for controlling operation of the actuator. In one possible embodiment, the first end plate 204 is connected to the actuator 210 and is displaceable with respect to the frame 202. In such an embodiment, the second end plate 206 may be fixed with respect to the frame 202, other arrangements are possible.

An electrolyte inlet 214 and an electrolyte outlet 216 may both be provided or carried on the frame 202. To those skilled in the art, it is known that the inlet and outlet may be reversed so that the outlet is above the inlet to allow gases to escape. These allow for electrolyte to be circulated in parallel through the plurality of electrowinning cells 10 on the frame 202 in manner described in greater detail below.

The frame 202 may also include or carry a cathodic bus bar 218 and an anodic bus bar 220 for providing connection of the anodes 12, 20 and cathodes 16 of the plurality of electrowinning cells 10 to a voltage/current source (not shown). More particularly, the first and second support lugs 136, 140, 144 and 148 of the electrowinning cells 10 are hung on the opposed support walls 224, 226 of the frame 202 with the cathodes 16 of those cells also engaging the cathodic bus bar 218 and the anodes 12, 20 of those cells also engaging the anodic bus bar 220 to complete the electrical connection.

The method of electrowinning a metal from an electrolyte containing ions of that metal comprises the step of passing the electrolyte with the ions of the metal through the electrowinning cell 10 described above. Still more particularly, the method includes the steps of: (a) loading a plurality of electrowinning cells 10 into the electrowinning press 200, (b) passing the electrolyte in parallel through the electrowinning cells held in the electrowinning press and (c) collecting the metal at a cathode 16 of each electrowinning cell.

The method may further include clamping the plurality of electrowinning cells together between first and second end plates 204, 206 of the electrowinning press 200. The method may also include the step of sealing the plurality of electrowinning cells together by compressing the seals 96, 100, 104, 108, 112, 114, 116 and 120 as described above.

The method may also include the step of feeding electrolyte in series to the plurality of electrowinning cells 10 through the electrolyte inlet 214 of the electrowinning press 200 that is aligned and interconnected with the aligned and interconnected electrolyte inlets 34, 46 of those cells. Further, the method may include the step of discharging the electrolyte in series from the plurality of electrowinning cells 10 through the aligned and interconnected electrolyte outlets 36, 48 of the cells that are also aligned and interconnected with the electrolyte outlet 216 of the electrowinning press.

Still further, the method may include the step of providing electrical connections for (a) the anodes 12, 20 of the electrowinning cells 10 by an anodic bus bar 220 carried on the electrowinning press 200 and (b) the cathodes 16 of the electrowinning cells 10 by a cathodic bus bar 218 carried on the electrowinning press. In addition, the method may include the step of hanging the electrowinning cells 10 in the electrowinning press 200 by means of the support lugs 136, 140, 144, 148 of the electrowinning cells engaging a support surface or walls 224, 226 of the frame 202 of the electrowinning press 200.

### EXPERIMENTAL SECTION

Chemical Considerations

The disclosed electrowinning cells, electrowinning press and method relate to an electrochemical reactor where an anodic reaction occurs, and a cathodic reaction occurs. Such a reaction may include the recovery of copper in ammoniacal solutions via electrowinning. In such a system the cathodic and anodic reaction in copper electrowinning are described by the following equations:

Cu(NH₃)₂⁺+e⁻=Cu+2NH₃,E₀=−0.10V vs SHE Equation 1

Cu(NH₃)₄²⁺+e⁻=Cu(NH₃)₂⁺+2NH₃,E₀=0.10V vs SHE Equation 2

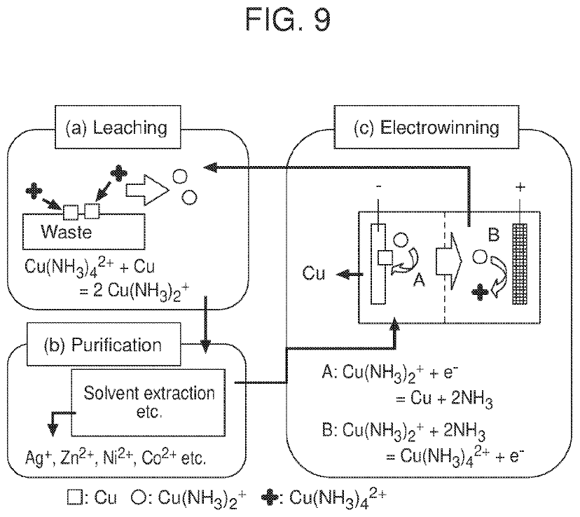

A schematic representation of electrowinning of copper in ammoniacal solutions is shown in FIG. 9. In the leaching process, copper bearing materials are leached in the ammonium solution containing Cu(NH₃)₄²⁺ ions (Cu²⁺), and the metallic copper)(Cu⁰) in the wastes reacts with the Cu²⁺ and is dissolved as Cu(NH₃)₂⁺ ions (Cu⁺). In the following solvent extraction stage, undesired impurities such as iron, aluminum and zinc, can be separated using a selective extractant. In the electrowinning stage, high purity Cu⁰ is obtained on the cathode from the Cu⁺ containing solution. Simultaneously, Cu⁺ is oxidized to Cu²⁺ on the anode and the produced Cu²⁺ is recycled back in the leaching stage as the oxidizing reagent.

Based on the nature of the cathodic and anodic reactions it is advantageous to prevent the circulation of Cu(NH₃)₄²⁺ back to the cathode where it would be reduced to Cu(NH₃)₂⁺. This circulation of anodic product would reduce the current efficiency by utilizing electrons for the reduction of copper that is not plating as metallic product.

Cell Geometry

To overcome these difficulties it is proposed that an electrolyte flow be established where the electrolyte containing an abundance of Cu(NH₃)₂⁺ (or more broadly cathode reactant) is brought into contact with the cathode 16. The electrolyte flow and geometry of the cell 10 is arranged in such a way that the cathode reactants, or barren solution lower in cathode reactants is transported to the anode 14, 20 where the remaining Cu(NH₃)₂⁺ is oxidized into Cu(NH₃)₄²⁺ in such a way that transfer back to the cathode 16 is minimized. Thus, the reactants/products of the anode 14, 20 are generally maintained separately from those of the cathode 16.

As described above, the geometry of the electrodes 14, 16 and 20 and spacing plates 24, 26 is arranged so that there exists a means for electrolyte to be supplied to and conveyed from the cell 10.

The spacer plates 24, 26 separate the electrodes 12, 16, 20 from each other and are constructed of such a material to make them electrical insulators preventing short circuiting of the electrodes. The plates 24, 26 allow space for electrolyte to be in communication with the anode 14, 20 and cathode 16. This space also allows a volume for the deposition of metal on the cathode 16 to be accomplished should the system require metallic deposition. A membrane or flow restrictors 38, 50 may be used to partition the anode compartments 14, 22 from the cathode compartment 18 to assist in regulating the flow from the anode side to the cathode side of the cell 10.

Sufficient space is provided between the flow restrictors 38, 50 and the cathode 16 so that the deposition of metal may occur uninhibited. The inlet ports 60, 62 in communication with the inlets 34, 46 and inlet plenum 52 are arranged in such a manner as to provide needed and uniform electrolyte flow to the cathode 16 and through the flow restrictors 38, 50. Further, inlets, outlets, and gaskets and/or inert coating on electrodes may be employed to prevent plating in the inlet or outlet ports. The flow restrictors 38, 50 are supported against the hydrostatic pressure caused by the electrolyte flow.

Press Arrangement

In the electrowinning press 200, a multiplicity of cells 10 are arranged in a plate and frame type press as shown in FIG. 7. This figure depicts how those skilled in the art may arrange the cells 10 as described into multi-cell arrangements. In this embodiment the electrowinning press 200 consists of a frame 202 which resists compressive forces exerted by a single or multiplicity of cylinders 210 on the series of electrodes 12, 16, 20 and spacers 24, 26. In operation the compressive force is sufficient to prevent or minimize the loss of electrolyte from the assembly. In this embodiment, the inlet is arranged on the opposite end from the outlet to provide uniform pressure drops across the multiple flow restrictors 38, 50 in the assembly. Electrical connections for the anodes 12, 20 and cathodes 16 are provided as shown with bus bars 218, 220. When the press is open the anodes 12, 20 and cathodes 16 are supported by the bus bars. The anode and cathode bus bars 218, 220 are arranged in such a way as to prevent short circuiting between the anodes 12, 20 and cathode 16. The spacer plates 24, 26 are supported by lugs 136, 140, 144, 148 which rest on the frame 202.

The assembly is operated by first closing the press 200 with the requisite number of cells 10 in the proper arrangement. The cells 10 are then filled with electrolyte and the electrolyte is then circulated through the cells. The current is supplied to begin the electrowinning process. In this embodiment, upon completion when the required amount of metal is deposited onto the cathodes 16, the fluid is drained and if needed the assembly is flushed. The press 200 is then opened where a gap is formed between the electrodes 12, 16, 20 and the spacing plates 24, 26 which allows removal of the metal formed on the cathodes 16. The process may then be repeated after any repairs or inspections.

Potential Benefits

It is anticipated that the described embodiments may be beneficial across a wide range of electrowinning applications, where electrowinning is described as reacting at least one ion in reduction at the cathode 16 and at least one ion in oxidation at the anodes 12, 20; further where the anodes 12, 20 are not consumed in the electrolytic reaction.

The potential benefits of the embodiments may include, but are not limited to:
Separation of the anodic and cathodic reactants.
Capturing gasses that are evolved in electrowinning.
Achieving higher current densities due to the forced convection of the electrolyte and enhanced mass transport of the reactants.
Fewer electrochemical cells required owing to the higher current densities.
Being able to flush and/or dry the cathodes prior to the opening of press by flushing or drying in place.
Reducing or eliminating fumes or off gas of electrolyte by enclosure of electrolyte from communication with the atmosphere.

This disclosure may be considered to relate to the following items:

1. A spacer plate for an electrowinning cell, comprising:

a body outlining sidewalls of an electrolyte chamber, said body including an electrolyte inlet and an electrolyte outlet; and

a flow restrictor carried on said body, said flow restrictor extending across said electrolyte chamber and dividing said electrolyte chamber into a cathode compartment and an anode compartment.

2. The spacer plate of item 1, wherein said electrolyte inlet is in communication with said cathode compartment and said electrolyte outlet is in communication with said anode compartment.

3. The spacer plate of item 2, further including an inlet plenum in said body extending across a first sidewall of the electrolyte chamber.

4. The spacer plate of item 3, further including a plurality of inlet ports at said first sidewall of said electrolyte chamber whereby electrolyte flows from said electrolyte inlet through said electrolyte inlet plenum and then through said plurality of inlet ports into said cathode compartment.

5. The spacer plate of item 4, further including an outlet plenum in said body extending across a second sidewall of the electrolyte chamber.

6. The spacer plate of item 5, further including a plurality of outlet ports at the second sidewall of the electrolyte chamber whereby the electrolyte flows from the anode compartment through the plurality of outlet ports and then through the outlet plenum to the electrolyte outlet.

7. The spacer plate of item 6, wherein the first sidewall is opposite the second sidewall.

8. The spacer plate of item 7, further including a flow restrictor support extending across said electrolyte chamber against a face of the flow restrictor oriented toward the anode compartment and supporting the flow restrictor against flow pressure from the cathode compartment.

9. The spacer plate of item 8, wherein the flow restrictor support includes a plurality of apertures between a plurality of supports extending across the electrolyte chamber in a first direction between the first sidewall and the second sidewall and in a second direction between a third sidewall and a fourth sidewall opposite the third sidewall.

10. The spacer plate of item 7, further including a first seal on a first side of said body extending around said electrolyte inlet, said inlet plenum and said cathode compartment.

11. The spacer plate of item 10, further including a second seal on a second side of said body extending around said electrolyte outlet, said outlet plenum and said anode compartment.

12. The spacer plate of item 11, further including a third seal on the first side of the body extending around the electrolyte outlet.

13. The spacer plate of item 12, further including a fourth seal on the second side of the body extending around the electrolyte inlet.

14. The spacer plate of item 13, further including a first support lug projecting from a first edge of the body and a second support lug projecting from a second edge of said body.

15. The spacer plate of item 1, wherein said body further includes a channel outlining said cathode compartment.

16. The spacer plate of item 15, further including a deformable band pressed against the flow restrictor down into the channel in order to hold the flow restrictor in place.

17. An electrowinning cell, comprising:

a first anode associated with a first anode compartment;

a cathode in a cathode compartment;

a second anode associated with a second anode compartment;

a first spacer plate between the first anode and the cathode wherein said first spacer plate includes a first body outlining sidewalls of an electrolyte chamber, said first body including a first electrolyte inlet, a first electrolyte outlet and a first flow restrictor, said first flow restrictor extending across said electrolyte chamber and dividing said electrolyte chamber into the cathode compartment and the first anode compartment; and

a second spacer plate between the cathode and the second anode wherein said second spacer plate includes a second body also outlining the sidewalls of the electrolyte chamber, said second body including a second electrolyte inlet, a second electrolyte outlet and a second flow restrictor, said second flow restrictor extending across said electrolyte chamber and dividing said electrolyte chamber into the cathode compartment and the second anode compartment.

18. The electrowinning cell of item 17, further including a first anode bus bar at a top end of the first anode and a second anode bus bar at a top end of the second anode.

19. The electrowinning cell of item 18, further including a cathode bus bar at a top end of the cathode.

20. The electrowinning cell of item 19, wherein the first and second anode bus bars are height aligned.

21. The electrowinning cell of item 20, wherein the cathode bus bar is height offset from the first and second anode bus bars.

22. The electrowinning cell of any of items 17-21, wherein said first electrolyte inlet and said second electrolyte inlet are in communication with said cathode compartment, said first electrolyte outlet is in communication with said first anode compartment and said second electrolyte outlet is in communication with the second anode compartment.

23. The electrowinning cell of item 22, further including an electrolyte inlet plenum in said first body and said second body extending across a first sidewall of the electrolyte chamber.

24. The electrowinning cell of item 23, further including a first plurality of inlet ports at said first sidewall of said electrolyte chamber whereby electrolyte flows from said first electrolyte inlet through said electrolyte inlet plenum and then through said first plurality of inlet ports into said cathode compartment and a second plurality of inlet ports at said first sidewall of said electrolyte chamber whereby the electrolyte flows from said second electrolyte inlet through said electrolyte inlet plenum and then through said second plurality of inlet ports into said cathode compartment.

25. The electrowinning cell of item 24, further including a first electrolyte outlet plenum in said first body and extending across a second sidewall of the electrolyte chamber and a second electrolyte outlet plenum in said second body also extending across the second sidewall of the electrolyte chamber.

26. The electrowinning cell of item 25, further including a first plurality of outlet ports at the second sidewall of the electrolyte chamber whereby the electrolyte flows from the first anode compartment through the first plurality of outlet ports and then through the first electrolyte outlet plenum to the first electrolyte outlet and a second plurality of outlet ports at the second sidewall of the electrolyte chamber whereby the electrolyte flows from the second anode compartment through the second plurality of outlet ports and then through the second electrolyte outlet plenum to the second electrolyte outlet.

27. The electrowinning cell of item 26, wherein the first sidewall of the electrolyte chamber is opposite the second sidewall of the electrolyte chamber.

28. The electrowinning cell of item 27, further including a first flow restrictor support extending across said electrolyte chamber against a face of the first flow restrictor oriented toward the first anode compartment and a second flow restrictor support extending across said electrolyte chamber against a face of the second flow restrictor oriented toward the second anode compartment.

29. The electrowinning cell of item 28, wherein the first flow restrictor support includes a first plurality of apertures between a first plurality of supports extending across the electrolyte chamber in a first direction between the first sidewall and the second sidewall of the electrolyte chamber and in a second direction between a third sidewall and a fourth sidewall opposite the third sidewall of the electrolyte chamber and the second flow restrictor support includes a second plurality of apertures between a second plurality of supports extending across the electrolyte chamber in the first direction between the first sidewall and the second sidewall of the electrolyte chamber and in the second direction between the third sidewall and the fourth sidewall opposite the third sidewall of the electrolyte chamber.

30. The electrowinning cell of item 29, further including a first seal on a first side of said first body extending around said first electrolyte inlet, said inlet plenum and said cathode compartment and a first seal on a first side of said second body extending around said second electrolyte inlet, said inlet plenum and said cathode compartment.

31. The electrowinning cell of item 30, further including a second seal on a second side of said first body extending around said first electrolyte outlet, said first electrolyte outlet plenum and said first anode compartment and a second seal on a second side of said second body extending around said second electrolyte outlet, said second electrolyte outlet plenum and said second anode compartment.

32. The electrowinning cell of item 31, further including a third seal on the first side of the first body extending around the first electrolyte outlet and a third seal on the first side of the second body extending around the second electrolyte outlet.

33. The electrowinning cell of item 32, further including a fourth seal on the second side of the first body extending around the first electrolyte inlet and a fourth seal on the second side of the second body extending around the second electrolyte inlet.

34. The electrowinning cell of item 33, further including (a) a first support lug projecting from a first edge of the first body and a second support lug projecting from a second edge of said first body and (b) a first support lug projecting from a first edge of the second body and a second support lug projecting from a second edge of said second body.

35. The electrowinning cell of item 17, wherein said first body further includes a first channel outlining said cathode compartment and a first deformable band is pressed against the first flow restrictor down into said first channel in order to hold the first flow restrictor in place.

36. The electrowinning cell of item 35, wherein said second body further includes a second channel outlining said cathode compartment and a second deformable band is pressed against the second flow restrictor down into the second channel in order to hold the second flow restrictor in place.

37. An electrowinning press, comprising:

a frame;

a first end plate carried on said frame;

a second end plate carried on said frame;

a plurality of electrowinning cells carried on said frame between said first end plate and said second end plate; and

a clamp assembly adapted to clamp said plurality of electrowinning cells between said first end plate and said second end plate.

38. The electrowinning press of item 37, wherein said clamp assembly includes an actuator adapted for urging the first end plate and the second end plate together.

39. The electrowinning press of item 38, wherein the clamp assembly further includes a controller connected to the actuator.

40. The electrowinning press of item 38, wherein the first end plate is connected to the actuator and is displaceable with respect to the frame.

41. The electrowinning press of item 40, wherein the second end plate is fixed with respect to the frame.

42. The electrowinning press of item 41, further including an electrolyte inlet carried on said frame.

43. The electrowinning press of item 42, further including an electrolyte outlet carried on said frame.

44. The electrowinning press of item 42, further including a cathodic bus bar carried on said frame.

45. The electrowinning press of item 44, further including an anodic bus bar carried on said frame.

46. The electrowinning press of any of items 37-45, wherein each of the plurality of electrowinning cells are of a structure as set forth in any of items 17-36.

47. A method of electrowinning a metal from an electrolyte containing ions of said metal, comprising:

passing the electrolyte with the ions of the metal through an electrowinning cell as set forth in any of items 17-36.

48. The method of item 47, including winning copper metal from the electrolyte comprising copper ions in ammoniacal solution.

49. A method of electrowinning a metal from an electrolyte containing ions of the metal, comprising:

loading a plurality of electrowinning cells into an electrowinning press;

passing the electrolyte in parallel through the plurality of electrowinning cells held in the electrowinning press; and

collecting the metal at a cathode of each of the electrowinning cells.

50. The method of item 49, further including clamping the plurality of electrowinning cells together between a first end plate and a second end plate of the electrowinning press.

51. The method of item 50, including sealing the plurality of electrowinning cells together.

52. The method of item 49, including feeding the electrolyte in series to the plurality of electrowinning through an electrolyte inlet of the electrowinning press.

53. The method of item 52, including discharging the electrolyte in series from the plurality of electrowinning cells through an electrolyte outlet of the electrowinning press.

54. The method of item 53, including providing electrical connections for (a) anodes of the plurality of electrowinning cells by an anodic bus bar carried of the electrowinning press and (b) cathodes of the plurality of electrowinning cells by a cathodic bus bar of the electrowinning press.

55. The method of item 54, further including hanging the plurality of electrowinning cells in the electrowinning press by means of support lugs of the electrowinning cells engaging a support surface of the electrowinning press.

Each of the following terms written in singular grammatical form: “a”, “an”, and the“, as used herein, means “at least one”, or “one or more”. Use of the phrase One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The term “method”, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Terms of approximation, such as the terms about, substantially, approximately, etc., as used herein, refers to ±10% of the stated numerical value. Use of the terms parallel or perpendicular are meant to mean approximately meeting this condition, unless otherwise specified.

It is to be fully understood that certain aspects, characteristics, and features, of the spacer plate, electrowinning cell, electrowinning press and method, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the spacer plate, electrowinning cell, electrowinning press and method which are illustratively described and presented in combination or sub-combination in the context or format of a single embodiment may also be illustratively described and presented in the context or format of a plurality of separate embodiments.

Although the spacer plate, electrowinning cell, electrowinning press and method have been illustratively described and presented by way of specific exemplary embodiments, and examples thereof, it is evident that many alternatives, modifications, or/and variations, thereof, will be apparent to those skilled in the art. For example, another embodiment of the electrowinning cell may include (a) the plurality of outlet ports 68 formed between the first anode 12, an extension of the ribs or supports 84 of the first flow restrictor support 74 extending along the sidewall 64 and the sidewall 64 of the first spacer plate 24 and (b) the plurality of outlet ports 70 formed between the second anode 20, an extension of the ribs or supports 90 of the second flow restrictor support 78 extending along the sidewall 64 and the sidewall 64 of the second spacer plate 26. It is intended that all such alternatives, modifications, or/and variations, fall within the spirit of, and are encompassed by, the broad scope of the appended claims.

1. A spacer plate for an electrowinning cell, comprising:
a body outlining sidewalls of an electrolyte chamber, said body including an electrolyte inlet and an electrolyte outlet; and
a flow restrictor carried on said body, said flow restrictor extending across said electrolyte chamber and dividing said electrolyte chamber into a cathode compartment and an anode compartment wherein said electrolyte inlet is in communication with said cathode compartment and said electrolyte outlet is in communication with said anode compartment.

2. (canceled)

3. The spacer plate of claim 1, further including an inlet plenum in said body extending across a first sidewall of the electrolyte chamber.

4. The spacer plate of claim 3, further including a plurality of inlet ports at the first sidewall of said electrolyte chamber whereby electrolyte flows from said electrolyte inlet through said electrolyte inlet plenum and then through said plurality of inlet ports into said cathode compartment.

5. The spacer plate of claim 4, further including an outlet plenum in said body extending across a second sidewall of the electrolyte chamber.

6. The spacer plate of claim 5, further including a plurality of outlet ports at the second sidewall of the electrolyte chamber whereby the electrolyte flows from the anode compartment through the plurality of outlet ports and then through the outlet plenum to the electrolyte outlet.

7. The spacer plate of claim 6, wherein the first sidewall is opposite the second sidewall.

8. The spacer plate of claim 7, further including a flow restrictor support extending across said electrolyte chamber against a face of the flow restrictor oriented toward the anode compartment and supporting the flow restrictor against flow pressure from the cathode compartment.

9. The spacer plate of claim 8, wherein the flow restrictor support includes a plurality of apertures between a plurality of supports extending across the electrolyte chamber in a first direction between the first sidewall and the second sidewall and in a second direction between a third sidewall and a fourth sidewall opposite the third sidewall.

10. The spacer plate of claim 7, further including a first seal on a first side of said body extending around said electrolyte inlet, said inlet plenum and said cathode compartment.

11. The spacer plate of claim 10, further including a second seal on a second side of said body extending around said electrolyte outlet, said outlet plenum and said anode compartment.

12. The spacer plate of claim 11, further including a third seal on the first side of the body extending around the electrolyte outlet.

13. The spacer plate of claim 12, further including a fourth seal on the second side of the body extending around the electrolyte inlet.

14. The spacer plate of claim 13, further including a first support lug projecting from a first edge of the body and a second support lug projecting from a second edge of said body.

15. The spacer plate of claim 1, wherein said body further includes a channel outlining said cathode compartment.

16. The spacer plate of claim 15, further including a deformable band pressed against the flow restrictor down into the channel in order to hold the flow restrictor in place.

17. An electrowinning cell, comprising:
a first anode associated with a first anode compartment;
a cathode in a cathode compartment;
a second anode associated with a second anode compartment;
a first spacer plate between the first anode and the cathode wherein said first spacer plate includes a first body outlining sidewalls of an electrolyte chamber, said first body including a first electrolyte inlet, a first electrolyte outlet and a first flow restrictor, said first flow restrictor extending across said electrolyte chamber and dividing said electrolyte chamber into the cathode compartment and the first anode compartment; and
a second spacer plate between the cathode and the second anode wherein said second spacer plate includes a second body also outlining the sidewalls of the electrolyte chamber, said second body including a second electrolyte inlet, a second electrolyte outlet and a second flow restrictor, said second flow restrictor extending across said electrolyte chamber and dividing said electrolyte chamber into the cathode compartment and the second anode compartment.

18. (canceled)

19. (canceled)

20. (canceled)

21. (canceled)

22. The electrowinning cell of claim 17, wherein said first electrolyte inlet and said second electrolyte inlet are in communication with said cathode compartment, said first electrolyte outlet is in communication with said first anode compartment and said second electrolyte outlet is in communication with the second anode compartment.

23. The electrowinning cell of claim 22, further including an electrolyte inlet plenum in said first body and said second body extending across a first sidewall of the electrolyte chamber.

24. The electrowinning cell of claim 23, further including a first plurality of inlet ports at said first sidewall of said electrolyte chamber whereby electrolyte flows from said first electrolyte inlet through said electrolyte inlet plenum and then through said first plurality of inlet ports into said cathode compartment and a second plurality of inlet ports at the first sidewall of said electrolyte chamber whereby the electrolyte flows from the second electrolyte inlet through said electrolyte inlet plenum and then through said second plurality of inlet ports into said cathode compartment.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. An electrowinning press, comprising:
a frame;
a first end plate carried on said frame;
a second end plate carried on said frame;
a plurality of electrowinning cells carried on said frame between said first end plate and said second end plate; and
a clamp assembly adapted to clamp said plurality of electrowinning cells between said first end plate and said second end plate.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)
